(19) United States
(12) Patent Application Publication
(10) Pub. No.: US 2005/0169634 A1
(43) Pub. Date: Aug. 4, 2005

(54) Bi-directional optical transceiver module and bi-directional optical transceiver package using the same

(76) Inventors: Gi-Tae Mun, Suwon-si (KR); Young-Kwon Yoon, Anyang-si (KR); Hyun-Ho Ryoo, Suwon-si (KR); Sun-Hyoung Pyo, Incheon (KR)

Correspondence Address: CHA & REITER, LLC, 210 ROUTE 4 EAST STE 103, PARAMUS, NJ, 07652, US

(21) Appl. No.: 10/913,065

(22) Filed: Aug. 6, 2004

(30) Foreign Application Priority Data
Jan. 29, 2004 (KR) 2004-5768

(51) Int. Cl. H04B 10/00

(52) U.S. Cl. 398/110

(57) ABSTRACT

A bidirectional optical transmission/reception module includes a sub-mount and a plane optical device that is mounted on the sub-mount for transmitting and receiving an optical signal. The module includes an optical fiber for inputting the optical signal from and outputting the optical signal to the outside of the bi-directional optical transmission/reception module. A stub into which the optical fiber is mounted protrudes conically at one end adjacent to the device to point the fiber end toward and planarly in alignment with the device. A support member has a hole formed at its one upstanding side, and the hole is penetrated by the conical end of the stub.

### CLAIM OF PRIORITY

This application claims priority under 35 U.S.C. § 119 to an application entitled “Bi-directional Optical Transceiver Module and Bi-directional Optical Transceiver Package Using the Same,” filed in the Korean Intellectual Property Office on Jan. 29, 2004 and assigned Serial No. 2004-5768, the contents of which are incorporated herein by reference.

### BACKGROUND OF THE INVENTION

1. Field of the Invention

The present invention relates generally to optical communication devices, and in particular, to alignment of an optical axis between optical communication devices.

2. Description of the Related Art

FIG. 1 is a perspective view of a plane optical device according to the prior art. Referring to FIG. 1, a conventional plane optical device 100 includes a connector 120, a photodiode 130, a semiconductor light source 140, and an optical detector 150 for monitoring the intensity of light output from the semiconductor light source 140, all of which are arranged on a semiconductor substrate 101. A waveguide 110 having a Y-branch structure is formed on the semiconductor substrate 101 such that it is Y-branched to the photo diode 130 and the semiconductor light source 140.

The photodiode 130 detects an optical signal input through the waveguide 110. The semiconductor light source 140 creates light having a predetermined wavelength and outputs the created light to outside of the plane optical device 100 through the waveguide 110.

Sub-waveguides of the Y-branched waveguide 110 face the photodiode 130 and the semiconductor light source 140, respectively. The plane optical device 100 operates in conjunction with a bi-directional optical transmission/reception module (not shown) or a bi-directional optical transmission/reception package whose optical axis is aligned with the optical axis of other optical devices, and is applied to an optical communication system.

The bi-directional optical transmission/reception module rests the plane optical device 100 shown in FIG. 1 on a lens holder (not shown) having an ‘L’ shape. A lens system (not shown) for coupling light input to and output from the plane optical device 100 is fixed to one side of one end of the plane optical device 100. Positioned on another side of the plane optical device 100 are optical signal transmission media such as optical fibers (not shown). These fibers output, externally from the bi-directional optical transmission/reception module, light from the distal end of the Y-branched sub-waveguides of the plane optical device 100 and serve to input, from outside of the bi-directional optical transmission/reception module, an optical signal to the plane optical device 100. The lens system intervenes between the two sides.

It has been suggested that a bi-directional optical transmission/reception module have a structure in which a ‘V’ groove is formed on the plane optical device 100 for directly mounting an optical fiber.

It has alternatively been suggested that the optical fiber be passively aligned at one end of the waveguide 110.

The bi-directional optical transmission/reception package includes the bi-directional optical transmission/reception module that is mounted inside a housing having a butterfly structure. This package externally outputs an optical signal created in the module, and inputs into the module an externally-received optical signal.

Passive alignment significantly reduces the cost of mass production, but degrades the reliability of products by creating a difference between products. SUMMARY OF THE INVENTION

It is an object of the present invention to provide bi-directional optical transmission/reception module that includes a plane optical device allowing products to have high reliability and permitting manufacture at high throughput.

To achieve the above and other objects, there is provided a bi-directional optical transmission/reception module which includes a sub-mount and, mounted on the sub-mount, a plane optical device for transmitting and receiving an optical signal. The module includes an optical fiber for inputting the optical signal from outside of the module and for outputting the optical signal externally from the module. A stub into which the optical fiber is mounted has a protrusion having an end adjacent and protruding toward the device. A support member has a base upon which the sub-mount rests, and a hole formed at a side of the sub-mount. The stub is disposed to penetrate the hole. A stub holder supports the stub and fixes the stub at that side of the sub-mount.

### BRIEF DESCRIPTION OF THE DRAWINGS

The above features and advantages of the present invention will become more apparent from the following detailed description when taken in conjunction with the accompanying drawings in which:

FIG. 1 is a perspective view of a plane optical device according to the prior art;

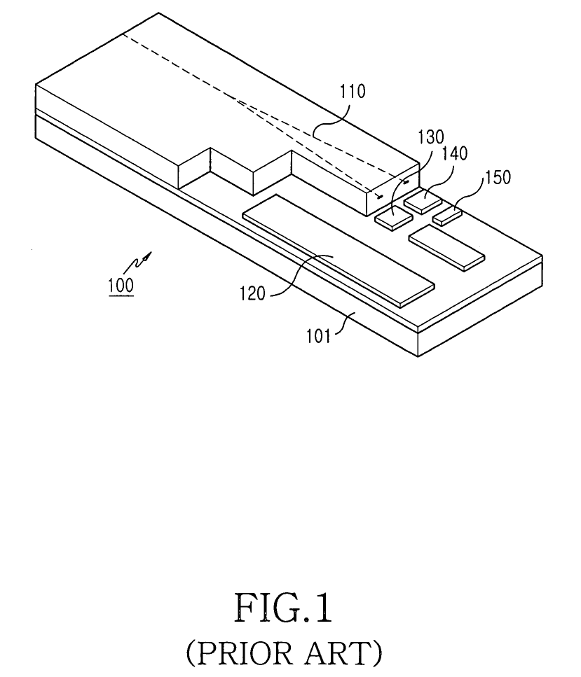

FIG. 2 is a side cross-sectional view of a bi-directional optical transmission/reception module according to a first embodiment of the present invention;

FIG. 3 is a plan view of a bi-directional optical transmission/reception package on which a bi-directional optical transmission/reception module according to a second embodiment of the present invention is mounted; and

FIG. 4 is a graph for explaining adhesion precision between a bi-directional optical transmission/reception module and an optical fiber, which is required by the bi-directional optical transmission/reception package shown in FIG. 3.

### DETAILED DESCRIPTION

Several preferred embodiments of the present invention are described below with reference to the annexed drawings. Detailed description of known functions and configurations is omitted for conciseness and clarity of presentation.

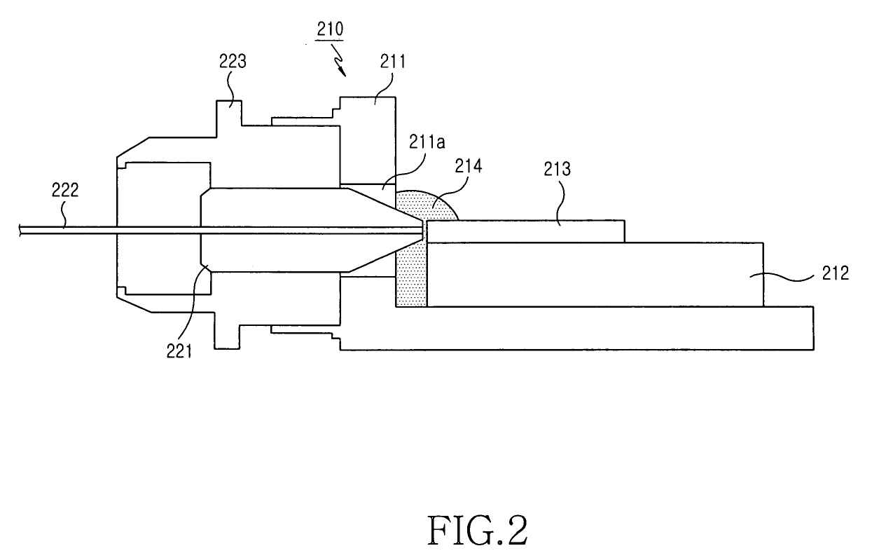

FIG. 2 is a side cross sectional view depicting, by way of illustrative and non-limitative example, a bi-directional optical transmission/reception module 210 according to a first embodiment of the present invention. The module 210 includes a sub-mount 212, a plane optical device 213, a stub 221, a support member 211, a stub holder 223, and a refractive index matching layer 214. The plane optical device 213 is rested on the sub-mount 212 and transmits or receives an optical signal.

The sub-mount 212 is rested on a base of the support member 211 and the plane optical device 213 is rested on the top surface of the support member 211. The plane optical device 213 may have active optical devices (not shown) that are formed on a silicon substrate during a semiconductor manufacturing process for receiving or emitting light. The plane optical device 213 may be used as a structure for bi-directional optical transmission/reception by forming the Y-branched waveguide such that its sub-waveguides contact the active optical devices.

An optical fiber 222 is an element for inputting an optical signal from, and outputting an optical signal to the outside of, the bi-directional optical transmission/reception module 210. The optical fiber 222 is positioned adjacent to the end of the plane optical device 213 by the stub 221 and is mounted within the stub. The end of the stub 221 that is adjacent to one end of the plane optical device 213 protrudes conically. Since a conical protrusion of the stub 221 is positioned adjacent to one end of the plane optical device 213, there is no need to include means for further coupling optical signals traveling back and forth between the plane optical device and the optical fiber 222.

A hole 211a for supporting the stub 221 is formed at one side of the support member 211. The stub 221 penetrates the hole 211a, with the stub holder 223 fixing the stub at one side of the support member 211.

The refractive index matching layer 214, comprising a material such as epoxy or silicon between the stub 221 and the plane optical device 213, minimizes a difference in refractive index between the respectively adjacent ends of the device and the optical fiber 222.

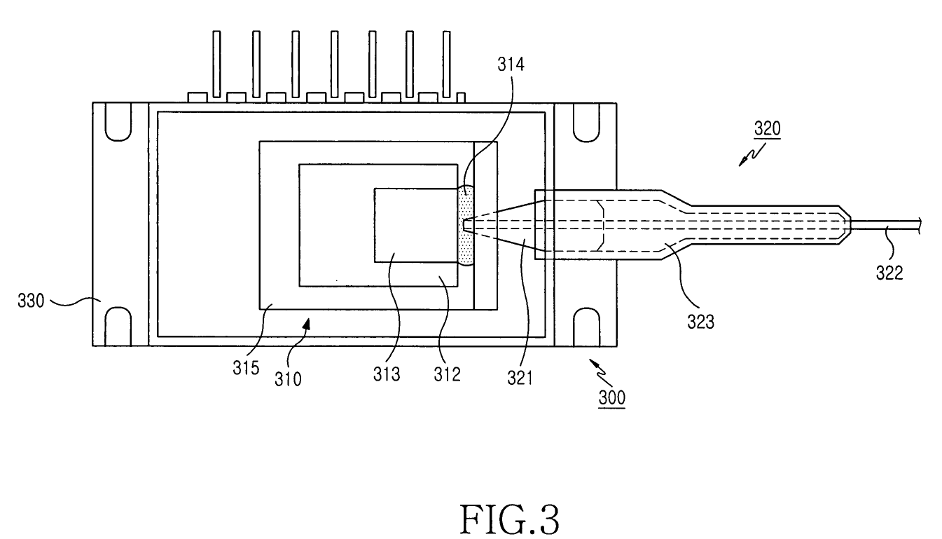

FIG. 3 is an exemplary plan view of a bi-directional optical transmission/reception package 300 on which is mounted a bi-directional optical transmission/reception module 310 according to a second embodiment of the present invention. the package further including a housing 330 on which the module is directly mounted.

The bi-directional optical transmission/reception module 310 includes a sub-mount 312, a support member 315, a refractive index matching layer 314, a plane optical device 313, a stub 321, an optical fiber 322, and a stub holder 323 for supporting the stub.

The sub-mount 312 supporting the plane optical device 313 has a structure in which active devices (not shown) for receiving or emitting light and Y-branched sub-waveguides (not shown) for dividing optical signals input from and output to the active devices are formed on a semiconductor substrate.

The stub 321 has a conical protrusion that is positioned adjacent to one end of the plane optical device 313. The optical fiber 322 is mounted axially at the center of the stub 321. The optical fiber 322 is a medium for inputting optical signals to the plane optical device 313 and outputting optical signals from the optical device to outside the bi-directional optical transmission/reception package 300. The optical fiber 322 is disposed with its optical axis is aligned adjacent to the plane optical device 313.

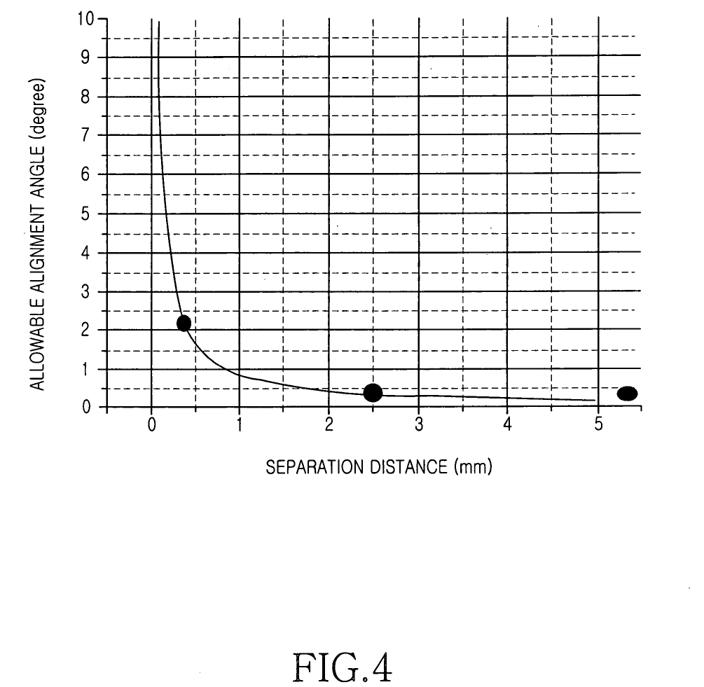

FIG. 4 is a graph for explaining adhesion precision between the bidirectional optical transmission/reception module 310 and the optical fiber 322, the adhesion precision being required by the bi-directional optical transmission/reception package 300 shown in FIG. 3. Referring to FIG. 4, the x-axis corresponds to the separation distance between the stub 321 and the plane optical device 313, and the y-axis corresponds to the allowable alignment error associated with that distance. As the separation distance increases, the allowable alignment error decreases, and, as the separation distance decreases, the allowable alignment error increases.

When, in particular, the separation distance between the stub 321 and the plane optical device 313 is more than 0.5 millimeters (mm), the allowable alignment angle corresponding to the allowable alignment error is less than 2°. However, as the separation distance between the stub 321 and the plane optical device 313 dips below 0.5 mm, the allowable alignment angle varies from 2° to infinity.

The present invention advantageously minimizes the separation distance between the stub 321 and the plane optical device 313 by forming the protrusion of the stub 321 adjacent to the plane optical device 313 into a conical shape. This simplifies alignment of the optical axis, and maximizes the allowable alignment error.

The base of the support member 315 supports the sub-mount 312 and the support member has at one side a hole (not shown) that the stub 321 penetrates. The refractive index matching layer 314 which minimizes the difference in refractive index between the optical fiber 322 and the plane optical device 313 is applied between the plane optical device 313 and the stub 321.

According to the present invention, by configuring and positioning the stub 221, 321 of the bi-directional optical transmission/reception module 210, 310 to protrude from the lens holder towards the plane optical device 213, 313, a combined loss caused by optical axis alignment of the optical fiber and the plane optical device is minimized, and the threshold at which alignment error between the plane optical device and the optical fiber becomes unacceptable can be increased.

While the invention has been shown and described with reference to certain preferred embodiments thereof, it will be understood by those skilled in the art that various changes in form and details may be made therein without departing from the spirit and scope of the invention as defined by the appended claims.

1. A bi-directional optical transmission/reception module which includes a sub-mount and, mounted on the sub-mount, a plane optical device for transmitting and receiving an optical signal, said module comprising:
an optical fiber for inputting the optical signal from outside of said module and for outputting the optical signal externally from said module;
a stub into which the optical fiber is mounted, the stub having a protrusion, the protrusion having an end adjacent to and protruding toward said device;
a support member having a base upon which the sub-mount rests, a side, and a hole formed at said side, the stub being disposed to penetrate the hole; and
a stub holder for supporting the stub, and fixing the stub at said side.

2. The bi-directional optical transmission/reception module of claim 1, further comprising a refractive index matching layer formed by application of epoxy for refractive index matching between the protrusion and the plane optical device.

3. The bi-directional optical transmission/reception module of claim 1, further comprising a refractive index matching layer formed by application of silicon for refractive index matching between the protrusion and the plane optical device.

4. The bi-directional optical transmission/reception module of claim 1, wherein the protrusion has a conical shape at said end adjacent to said device.

5. The bi-directional optical transmission/reception module of claim 4, wherein the plane optical device has two faces, said faces being opposite, the conically-shaped end pointing in a direction generally parallel to said faces.

6. The bi-directional optical transmission/reception module of claim 1, wherein the sub-mount comprises at least one active device formed on a silicon substrate.

7. The bi-directional optical transmission/reception module of claim 1, wherein the sub-mount comprises at least one Y-branched sub-waveguide.

8. The bi-directional optical transmission/reception module of claim 1, wherein a separation distance between the stub and the device is less than 0.5 mm.

9. A bi-directional optical transmission/reception package comprising:
a bi-directional optical transmission/reception module that receives and transmits optical signals, said module having a plane optical waveguide device, said device having an end, said module further having a stub, the stub having a conical portion positioned adjacent to said end, said module also having an optical fiber that is mounted within the stub and whose optical axis is arranged along said device; and
a housing for mounting said module, said housing having an end and a side at the housing end, the stub penetrating said side and being coupled to said housing end.

10. The bi-directional optical transmission/reception package of claim 9, wherein the stub has an end adjacent to said device, said module further comprising:
a sub-mount for supporting the plane optical device;
a support member having a base for supporting the sub-mount, having one upstanding side and having a hole formed in said upstanding side, the stub penetrating said hole; and
a refractive index matching layer, applied between said device and the stub end, for matching a difference in refractive index between the optical fiber and said device.

11. The bi-directional optical transmission/reception module of claim 10, wherein the sub-mount comprises at least one active device formed on a silicon substrate.

12. The bi-directional optical transmission/reception module of claim 10, wherein the sub-mount comprises at least one Y-branched sub-waveguide.

13. The bi-directional optical transmission/reception module of claim 9, wherein the plane optical device has two faces, said faces being opposite, said conical portion pointing in a direction generally parallel to said faces.

14. The bi-directional optical transmission/reception module of claim 9, wherein a separation distance between the stub and the device is less than 0.5 mm.

15. The bi-directional optical transmission/reception module of claim 9, further comprising a refractive index matching layer formed by application of epoxy for refractive index matching between the protrusion and the plane optical device.

16. The bi-directional optical transmission/reception module of claim 9, further comprising a refractive index matching layer formed by application of silicon for refractive index matching between the protrusion and the plane optical device.

17. An apparatus for configured for positioning an end of an optical fiber adjacent to a plane optical waveguide device to allow bi-directional optical signaling between the device and the optical fiber, said device having two opposite outer faces, said positioning entailing the alignment of said end to point between said faces and being performed by radially surrounding said end with a stub, holding said stub with a stub holder, and mounting said device in fixed relation to the stub holder.

18. The apparatus of claim 17, wherein the stub is conically-shaped at said end.

19. The apparatus of claim 17, comprising a support member for the mounting in fixed relation, the stub having an end that protrudes from the support member.

20. The apparatus of claim 19, wherein the stub end is conically-shaped.
